(19) United States
(12) Patent Application Publication
(10) Pub. No.: US 2017/0158438 A1
(43) Pub. Date: Jun. 8, 2017

(54) STORAGE FACILITY FOR STACKABLE GOODS AND METHOD FOR STORING STACKABLE GOODS

(71) Applicant: SIEMENS AKTIENGESELLSCHAFT, MUENCHEN (DE)

(72) Inventor: PETER BERDELLE-HILGE, KONSTANZ (DE)

(21) Appl. No.: 15/335,975

(22) Filed: Oct. 27, 2016

(30) Foreign Application Priority Data
Dec. 4, 2015 (DE) 20 2015 008 328.5

(51) Int. Cl. B65G 57/00; B07C 3/02

(52) U.S. Cl. CPC B65G 57/00; B07C 3/02

(57) ABSTRACT

A storage facility for the storage of stackable goods, especially stackable postal item containers, includes at least one storage device and at least one stacking device. The at least one storage device includes storage locations. At least one of the storage locations is configured to receive at least two items of goods stacked on top of one another. A mechanism is configured to move the at least one storage location and/or a further storage location within the storage facility, and the at least one stacking device is configured to stack one or more of the items of goods into the at least one storage location from below and/or unstack one or more of the items of goods from the at least one storage location from below. A method for storing stackable goods, especially stackable postal item containers, is also provided.

### CROSS-REFERENCE TO RELATED APPLICATION

This application claims the priority, under 35 U.S.C. §119, of German Patent Application DE 20 2015 008 328.5, filed Dec. 4, 2015; the prior application is herewith incorporated by reference in its entirety.

### BACKGROUND OF THE INVENTION

### Field of the Invention

The invention relates to the technical field of storage facilities for stackable goods, especially for postal item containers. The invention also relates to a method for storing stackable goods.

Storage facilities are central elements during goods consignment in manufacturing plants, warehouses and sorting systems and are intended to make possible at the same time a high storage density and a quick and reliable storage and picking of the goods, which is technically simple to realize and thus cost effective. Sorting processes frequently require a number of sorting passes, between which the goods are held in intermediate storage in the storage facility. An advantageous embodiment of the storage facility makes it possible to carry out the entire sorting process in an efficient manner. Of particular importance are sorting processes in postal item sorting systems, in which the postal items provided with delivery information are sorted in accordance with a sorting criterion, for example the delivery walk sequence of the mail carrier.

Sorting methods, especially multipass sorting methods, are used in postal sorting systems, in which storage of the goods in batches during the sorting processes in a sequence, both between the sorting passes and also after the last concluding sorting pass, belongs to the sorting result, so that a strict adherence to that sequence represents a basic system requirement. Since storage space is a limit to capacity in already existing sorting systems, because of the growing volume of postal items, achieving a high storage density is already a decisive advantage.

The prior art for storage facilities in sorting systems is a manual storage by operating personnel of individual goods as a vertical stack in container carts, which are disposed along the sorting system and are used as intermediate storage. In postal sorting systems the goods are postal item containers, wherein the postal item containers contain one or more postal items, i.e. letters, packets and/or packages. A number of items of goods form a stack. The goods arrive at random and the sequence of the storage is frequently oriented to the sequence of the unloading, so that the operating personnel must cover distances between the container carts.

In another device there is intermediate storage of the postal item containers individually in storage locations that are disposed in spur paths to the right and to the left along a main path.

Another, fully-automatic device includes a suspended movable robot system on a frame with a load receiving device with which vertical stacks formed of items of goods, especially postal item containers disposed in lines and rows, are able to be built up and taken down from above in a storage surface with a load receiving device.

For the manual storage of items of goods, especially of postal item containers in container carts with heavy items of goods, a disproportionate load is imposed on the operating personnel and the ergonomics of the operating personnel restrict the maximum height of the stack and thus the storage density. Above and beyond that issue, human operation represents a significant source of errors for adhering to the correct sequence during the sorting process and limits the speed of the intermediate storage, and the distances covered by the operating personnel slow down the sorting process even more. In the case of storage in spur paths, with only one item of goods in a spur path in each case, the storage density which achieved is very low. With the fully automatic device of the robot system, the frame of the robot system, including the load receiving device, must be disposed higher than the maximum stack height and the load receiving device must be able to carry the weight of the entire stack, so that the technical realization is complex and thus expensive.

### SUMMARY OF THE INVENTION

It is accordingly an object of the invention to provide an improved storage facility for stackable goods and an improved method for storing stackable goods, which overcome the hereinafore-mentioned disadvantages of the heretofore-known facilities and methods of this general type, which are technically simple to realize and operate and which at the same time make a high storage density possible.

With the foregoing and other objects in view there is provided, in accordance with the invention, a storage facility for the storage of stackable goods, especially for the storage of stackable postal item containers. The storage facility includes at least one storage device and at least one stacking device. The at least one storage device includes storage locations. At least one storage location is embodied to accept at least two items of goods stacked on one another. The storage facility includes a mechanism that is embodied to move the at least one and/or a further storage location within the storage facility. The at least one stacking device is embodied to stack one or more items of goods from below into the at least one storage location and/or to unstack them from below from the at least one storage location.

In order to make possible an especially simple stacking and/or unstacking from below, the at least one stacking device can be embodied so that one item or the number of items of goods are stacked into the at least one storage location and/or unstacked from the at least one storage location in such a way that a stack is built up or taken down from below, in that the one or more items of goods are inserted into the storage location and/or taken out of this storage location from the side and/or from below.

In order to move the at least one and/or a further storage location within the storage facility especially easily with little operating effort, so that an especially simple ability to reach the at least one and/or a further storage location is guaranteed, the at least one storage device can be a rotating storage device, which is able to be rotated with the mechanism about its axis of rotation and the storage locations of which are disposed in circumferential direction(s).

In order for the stacking device to be able to be operated with reduced operating effort, the at least one stacking device can be embodied to stack an item of goods and/or a number of items of goods into the at least one storage location and/or unstack them from the at least one storage location in an automated manner with the at least one stacking device.

In order to activate the stacking device directly, the storage facility can include a control device that is adapted to activate the at least one stacking device so that the one item of goods and/or the number of items of goods are stacked from below into the at least one storage location and/or are unstacked from below from the at least one storage location.

In accordance with a further embodiment the control device can be adapted to carry out a stacking and/or unstacking of the item of goods in a predetermined sequence. Then the items of goods, during or after the stacking and/or unstacking, are ordered in one or more stacks and the position of each item of goods in the stack concerned is known. The sequence can be selected for example so that, during the unstacking, no further separation of the goods of a stack and/or rotation of the rotating storage device occurs, through which the unstacking can occur especially quickly.

In order for the storage facility to be embodied especially for sorting, the control device can be adapted to determine the sequence of the stacking and/or unstacking for a sorting method, especially a multipass sorting method.

In order to further increase the storage density of the at least one rotating storage device and thus of the stacking device overall, the at least one storage device can include a number of storage segments. The storage segments are able to be moved jointly and/or independently of one another with the mechanism, wherein each storage segment includes one or more storage locations and the storage segments are disposed at the same height and/or at a distance above one another. An independent movement of the storage segments additionally makes it possible to increase stacking and/or unstacking speed, since there can already be positioning from a storage location located at a first storage segment to a storage location located at a second storage segment during the stacking and/or unstacking.

In order to prevent any tipping over of a stack, especially caused by movement of the storage location within the storage facility, and to allow greater stack heights and accelerations in the movement, the at least one storage location can include a support device that is embodied to support stacked goods.

In order to make possible an independent loading and unloading of the at least one storage device, the at least one stacking device can include both a loading device disposed in a loading area and also an unloading device disposed in an unloading area. The loading area and the unloading area can advantageously be disposed so that on one hand as many storage devices as possible can be placed next to one and on the other hand loading and unloading do not disrupt one another. Thus, loading and unloading can be carried out at different locations even with a fixed-location embodiment of a loading device and an unloading device.

In accordance with a further embodiment the storage facility can be embodied to be filled by a sorting system. In particular, one or more consignment paths of the sorting system can be used for sorting the goods and/or the at least one stacking device is optimized for a filling based on the sorting system. Furthermore, there can be a sorting of the goods of a stack when they are removed from the storage device into a number of goods groups or sorting groups through consignment paths. In this way the sorting system expands the storage facility.

In order to change a sequence of the goods of a stack among themselves and/or a sequence of the stacks in the storage locations, through which a sequence of unstacking can be planned more favorably with regard to its timing, the storage facility can include one or more stack parking spaces, which are embodied to receive and/or discharge one or more items of stacked goods. To this end the one or more stack parking spaces can be disposed advantageously along the at least one storage device.

In accordance with a further advantageous embodiment, the storage facility can be embodied for sorting, especially for sorting with a sorting method. This makes possible sorting that is efficient, since it is rapid and stable, and especially makes possible the carrying out of a sorting method with the storage facility.

In order to also make possible the stacking and/or unstacking from below into the at least one storage location in a simple manner with the stacking device when this storage location is already partly filled, the at least one stacking device can be embodied to stack one or more goods from below into a stack already present in the at least one storage location and/or to unstack goods from below from a stack already present in the at least one storage location.

In accordance with a further embodiment, the at least one storage location and/or the at least one stacking device can include a stack lifter, which is embodied to lift and hold one or more items of goods. The stack lifter is especially embodied to lift and hold that item or those items of goods that are already located in the storage location and are also remaining there during the stacking and/or unstacking of one or more items of goods from below. In this way the weight of the one item of goods or of the number of items of goods no longer imposes a load during stacking and/or unstacking on the one item of goods or of the number of items of goods lying below them, which makes stacking and/or unstacking easier, since this can be carried out especially easily from below without being weighed down by additional weight. In addition a form locking of the goods of a stack, rendering stacking and/or unstacking more difficult or impossible, is prevented in this way.

With the objects of the invention in view, there is also provided a method for storing stackable goods, especially stackable postal item containers, in at least one storage device containing storage locations, wherein the storage device is especially a rotating storage device. The method comprises the step of stacking one or more items of goods from below into at least one of the storage locations and/or of unstacking one or more items of goods from below from at least one of the storage locations.

In order to make possible the stacking and/or the unstacking at different storage locations of the at least one storage device and especially at the location where the stacking device and/or an operator is already positioned, there can be a movement of the at least one storage device with a mechanism, so that the at least one storage location is moved towards a stacking device and/or an operator, wherein one or more items of goods is stacked from below into the at least one storage location and/or is unstacked from below from the at least one storage location. Thus, the operator does not have to cover any distance, generating inactive waiting time, which speeds up stacking and/or unstacking. In addition, the stacking device can be installed in a fixed location.

In accordance with a further advantageous embodiment there can be an allocation of an item of goods to the at least one storage location for the stacking and/or unstacking for a sorting method, especially a multipass sorting method. In this way the storage facility makes possible efficient sorting, since the sorting is fast and stable.

In accordance with a preferred embodiment, the stacking can be done starting from a sorting system and/or the unstacking can be done going towards a sorting system. In this way the sorting system and its facilities, especially its consignment paths, can be employed as an extension of the storage facility.

In accordance with a further embodiment the method step of stacking one or more items of goods from below into at least one of the storage locations and/or unstacking one or more items of goods from below from at least one of the storage locations can include a stack already present in or remaining in this storage location or an item of goods already present in or remaining in the storage location being lifted and held. Thus, upon stacking and/or unstacking, especially from the side and/or from below, only the weight of the one or more items of goods that is being stacked and/or unstacked at the time must be carried. In addition a form locking between the goods of a stack, rendering stacking and/or unstacking more difficult or impossible, is prevented.

In order to achieve a reduction or elimination of sources of error in the carrying out of parts of the method and/or in the carrying out of the method as a whole and/or to carry it out with reduced operational effort, the entire method can be carried out automated and/or the stacking of one or more items of goods from below into at least one of the storage locations and/or the unstacking of one or more items of goods from below from at least one of the storage locations can be carried out in an automated manner and/or the rotation of the at least one rotating storage device can be carried out in an automated manner, so that the at least one storage location is moved towards a stacking device and/or an operator, wherein one or more items of goods are stacked from below into the at least one storage location and/or are unstacked from below from the at least one storage location and/or the allocation of an item of goods to the at least one storage location for the stacking and/or unstacking for a sorting method, especially a multipass sorting method, can be carried out in an automated manner and/or the stacking starting from and/or the unstacking towards a sorting system can be carried out in an automated manner and/or the method step of stacking of one or more items of goods from below into at least one of the storage locations and/or the unstacking of one or more items of goods from below from at least one of the storage locations can include a lifting or holding of a stack already present or remaining in the storage location or of an item of goods already present or remaining in the storage location being carried out in an automated manner.

Other features which are considered as characteristic for the invention are set forth in the appended claims.

Although the invention is illustrated and described herein as embodied in a storage facility for stackable goods and a method for storing stackable goods, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, overhead view of a storage facility;

FIG. 2 is an overhead view of rotating storage devices in a storage facility; and

FIG. 3 is a side-elevational view of a rotating storage device.

### DETAILED DESCRIPTION OF THE INVENTION

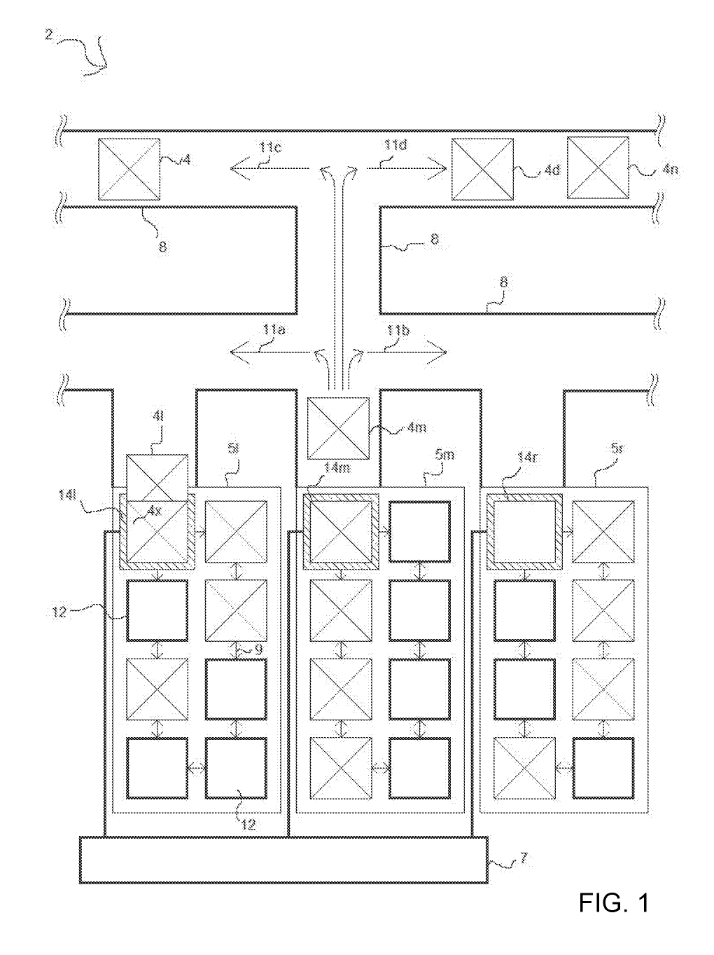

Referring now to the figures of the drawings in detail and first, particularly, to FIG. 1 thereof, there is seen a diagrammatic overhead view of a storage facility 2, which is embodied for the storage of stackable goods 4, especially for the storage of stackable postal item containers according to a preferred embodiment of the invention. The storage facility 2 is embodied for sorting, especially for sorting with a sorting method and for this purpose must include at least one storage device 5, which includes one or more storage locations 12. In this case the storage facility 2 includes three similarly embodied storage devices 5l, 5m, 5r and stacking devices 14l, 14m, 14r. The storage devices 5l, 5m, 5r each include eight storage locations 12, which are embodied to accept at least two items of goods 4 stacked on one another. In the situation shown in the diagram, the storage locations 12 are half filled with one or more items of goods 4 forming a vertical stack. It cannot be seen from the overhead view whether a storage location 12 is filled with an individual item of goods 4 or with a stack of items of goods 4. In the storage device 5l on the left in the diagram an item of goods 4l is just being stacked with the stacking device 14l from below into the storage location 12a. An item of goods 4x is already located in the storage location 12a and also remains in this location. To this end the item of goods 4x is lifted and held, while the item of goods 4l is pushed from the side and/or from below into the space that becomes free below the item of goods 4x. The item of goods 4l is thus inserted from the side into the storage location 12a, so that the stack is built up from below. The stack can also be built up from below by the item of goods 4l initially being pushed below the already existing stack, wherein this also entails a lateral movement, and the item of goods 4l is then inserted from below with an upwards movement into the space of the storage location 12a that has become free. In principle the stacking device 14l is not only embodied to stack one or more items of goods 4 from below into the storage location 12a, but is also embodied to unstack one or more items of goods 4 from below out of the storage location 12a. The stack is thus also taken down from below by a removal—likewise from the side and/or from below. The storage devices 5l, 5m, 5r are rectangular and disposed alongside one another, which makes it possible to utilize space especially well. Other embodiments of a storage device 5, such as circular rotating storage devices 10 for example, are likewise possible.

The stacking devices 14l, 14m, 14r are embodied for automated stacking of one and/or more items of goods 4 into the storage locations 12 and/or unstacking from the storage locations 12. To this end the storage facility 2 includes a control device 7 that is adapted to activate the stacking devices 14l, 14m, 14r so that one and/or more items of goods 4 as described above are stacked from the side and/or from below into the storage locations 12 from below and/or are unstacked from below from the storage locations 12. Through this process a stack is built up or taken down from below, by one or more items of goods 4 being inserted by a lateral movement into the storage location, wherein an insertion or removal takes place either from the side or from below. The control device 7 is also adapted to carry out a stacking and/or unstacking of the goods 4 in accordance with a predetermined sequence. The control device 7 is adapted to determine this sequence for a sorting method, especially a multipass sorting method.

The storage facility 2 includes a mechanism 9 that is embodied to move one and/or all storage locations 12 within the storage facility 2, especially within a storage device 5. Thus the storage locations are embodied so that their locations can be changed. The movement of the storage locations 12 can also be achieved by a movement of the entire storage device 5 itself. In this way the storage location 12 that is provided in accordance with the predetermined sequence as the next for stacking and/or unstacking is always moved towards the stacking device 14. To this end the storage locations 12 can be moved on slides and/or a drive device, for example a circulating conveyor belt, with the mechanism 9. In order to ensure that goods 4 stacked in the storage locations do not fall over during the movement, the storage locations in the overhead view of FIG. 1 have support facilities 40 which are not shown in the figure, but are embodied to support stacked goods 4.

The storage facility 2 is filled through consignment paths 8, starting from a sorting system 6 which is likewise not shown in FIG. 1. The consignment paths 8 can be used for sorting, both during stacking and also during unstacking. If, for example, the goods 4m have just been unstacked from the storage device 5m, between two sorting passes of a multipass sorting method, they can be transported in four different orientations 11a, 11b, 11c, 11d e.g. to the sorting system 6, before they are stacked into one of the storage locations 12 again. Sorting with the aid of the consignment paths 8 can also take place, if during stacking two items of goods 4d, 4n are transported following behind one another in the direction of the storage device 5r, advantageously, however, initially the second item of goods 4d is to be stacked into a common storage location 12. Then the first item of goods 4d could initially be transported in the orientation 11c and subsequently the second item of goods 4n is let past.

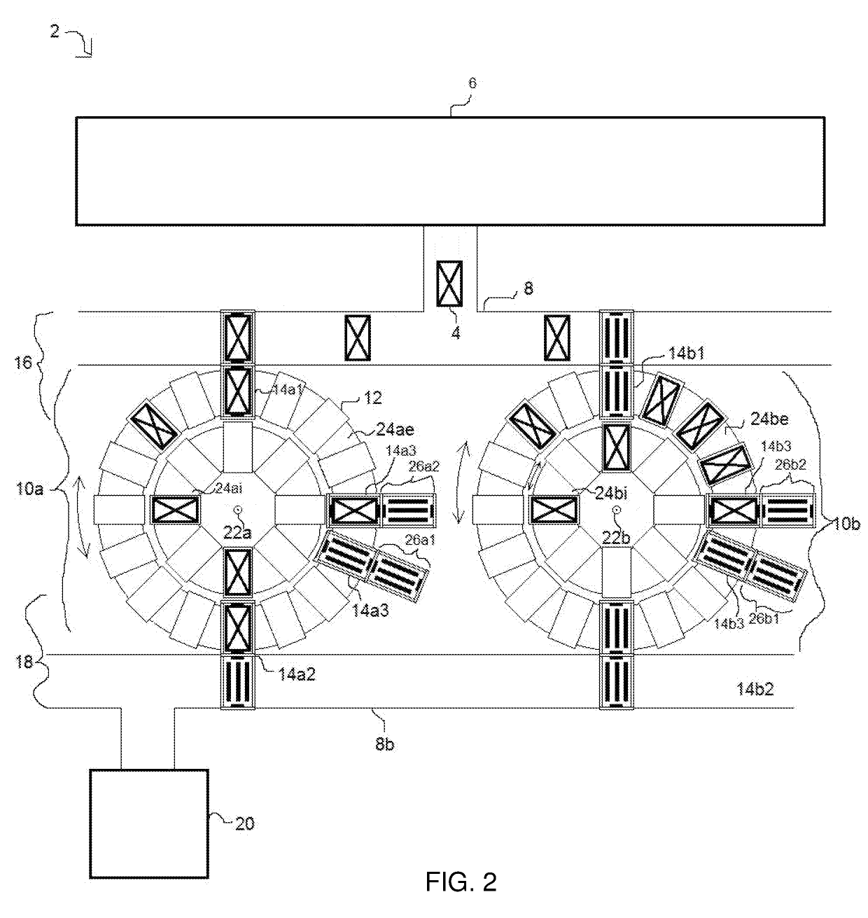

FIG. 2 shows a view onto a storage facility 2 for storing stackable goods 4 in accordance with a preferred embodiment of the invention. The storage facility 2 is adapted, optimized and especially embodied for use in a sorting system 6, especially in a postal sorting system, wherein the goods 4 are then stackable individual postal items or stackable postal item containers filled with letters, packets and/or packages.

In postal sorting systems the items of goods 4 are sorted according to a sorting criterion, which in most cases is an item of delivery information. Frequently the sorting is done according to a delivery walk sequence of the mail carrier. With a finite and predetermined number of sort criteria, such as in the case of the delivery information, multipass sorting methods are especially suitable, for example a radix sort. For a multipass sorting method sorting is carried out in a number of sorting passes, wherein a sequence of storage of the items of goods 4 in goods groups (“batches”) both between the sorting passes and also after the last concluding sorting pass, belongs to the sorting result. In order to carry out the multipass sorting method efficiently, an advantageously embodied storage facility 2 is indispensible. Therefore, the storage facility 2 is embodied for sorting, especially for sorting with a sorting method.

The storage facility 2 is embodied to be filled by the sorting system 6. To this end the items of goods 4 are transported over a consignment path 8 to one of two basically identically constructed storage devices 5. The storage devices are embodied as rotating storage devices 10a, 10b and are filled in a loading area 16, especially starting from the sorting system 6. The loading device 14a1 is embodied for stacking and unstacking, especially during and between the sorting passes of the multipass sorting method.

In order to increase the storage capacity, further rotating storage devices 10c, 10d, . . . , not shown in FIG. 1 can be built in. The rotating storage device 10a disposed on the left in the diagram is described in particular in greater detail below. However, all information given—apart from a different loading of the items of goods 4—also applies to the rotating storage device 10b, although the index a must be replaced with the index b in each case.

The rotating storage device 10a includes storage locations 12 disposed in circumferential direction(s), which especially describes a circulating direction. The storage locations 12 are provided and embodied to receive one or more items of goods 4 in a vertical stack. Each item of goods 4 is allocated to a storage location 12, into which it will be stacked from below or from which it will be unstacked from below. The allocation is done for a sorting method, especially a multipass sorting method. The rotating storage device 10a includes a stacking device 14a, which is embodied to stack one or more items of goods 4 from below into a storage location 12 and/or to unstack them from below from a storage location 12. Thus, such physically strenuous work does not have to be done manually by an operator. In order to achieve a reduced operating effort, the stacking device 14a can automate the process of stacking and/or unstacking from below. Advantageously each rotating storage device 10a, 10b is assigned at least one stacking device 14a, 14b.

The stacking and/or unstacking from below is done with the stacking device 14a. Since a fixed-location installation of the stacking device 14a is technically simpler to realize and less susceptible to errors in operation than a mobile installation, the stacking device 14a, on the sorting system 6 side, includes a loading and/or unloading device 14a1 disposed in the loading and/or unloading area 16 and an unloading device 14a2 disposed in an unloading area 18. The loading and/or unloading device 14a1 carries out the stacking and/or unstacking starting from or towards the sorting system 6, especially between the sorting passes. The unloading device 14a2 is especially adapted for unstacking after the last concluding sorting pass, but can also additionally be embodied for stacking. After conclusion of the sorting method or of the sorting process the goods 4 are unstacked in the unloading area 18 and transported through a second consignment path 8b to a container 20, which then leaves the storage facility 2 entirely. The loading and/or unloading area 16 and the unloading area 18 are disposed so that on one hand there is space for as many rotating storage devices 10a, 10b . . . as possible, and on the other hand loading and/or unloading and unloading of the two different rotating storage devices 10a and 10b can take place completely independently of one another. In preferred embodiments other than that which is shown in FIG. 2, the loading and/or unloading area (16) and the unloading area 18 are identical and/or the loading and/or unloading device 14_1 and the unloading device 14_2 are identical or different facilities.

The rotating storage device 10a is able to be rotated about its axis of rotation 22a. The axis of rotation 22a does not absolutely have to be embodied physically. The rotating storage device 10a is respectively rotated towards the fixed-location loading device 14a1 or unloading device 14a2, for stacking and/or unstacking of a storage location 12.

In order to further increase the storage capacity of the rotating storage device 10a and thus of the storage facility 2 as a whole, the rotating storage device 10a includes a number of rotating storage device segments 24, an inner rotating storage device segment 24ai and an outer rotating storage device segment 24ae, which are able to be rotated independently of one another about their common axis of rotation 22a and each of which include a number of storage locations 12. In an embodiment of a storage device 5 as a rotating storage device 10a it is especially easy to move one or more storage locations 12 within the storage facility 2 by rotation and thus embody the storage locations 12 with changeable locations. With the mechanism 9 the rotating storage device 10a and/or the individual rotating storage device segments 24ai, 24ae are able to be rotated about their common axis of rotation 22a. When two items of goods 4 following one another do not have to be stacked into the same rotating storage device segment 24ae, this also makes possible an increase in the speed of stacking. While an item of goods 4 is just being stacked into the outer rotating storage device segment 24ae, at the same time the storage location 12 of the inner rotating storage device segment 24ai provided for the subsequent item of goods 4 can be rotated towards the stacking device 14a. The unstacking can also be equally speeded up in the same way.

Unlike the depiction in FIG. 2, the inner rotating storage device segment 24ai and the outer rotating storage device segment 24ae can also be rotated jointly around their axis of rotation 22a. The storage capacity is also increased in this way. However, the inner rotating storage device segment 24ai cannot be rotated while the outer rotating storage device segment 24ae is being loaded and vice versa. A rotation of the entire rotating storage device 10a is preferably already taking place, however, during inactive waiting periods, for example while the further rotating storage device 10b is being loaded and/or unloaded. When only one joint movement of the rotating storage device segments 24ai, 24ae is required, the construction can be realized in a technically simpler manner, since only one common drive is required. This additionally has the advantage of a lower susceptibility to errors during operation.

In order to stack the subsequent item of goods 4, starting from the consignment path 8, into the free storage location 12 of the inner rotating storage device segment 24ai, the stacking device 14a is embodied to guide the item of goods 4 through below the storage location 12 of the outer rotating storage device segment 24ae. This is especially required when the inner rotating storage device segment 24ai and the outer rotating storage device segment 24ae are disposed at the same height. When rotating storage device segments 24 are disposed at a distance beneath one another, the stacking device 14 must be embodied to stack and/or unstack the items of goods at different heights or the number of rotating storage device segments 24 must each include their own stacking devices 14.

In order to make it possible to speed up the stacking and/or unstacking and/or to offer even more individual storage locations 12, even with a common storage device 5, without increasing the space requirement with a storage device 5, a storage device 5 includes a number of storage segments, which are able to be moved jointly and/or independently of one another with the mechanism 9. In this case too each storage segment includes one or more storage locations 12 and the storage segments are disposed at the same height or at a distance above one another. A movement of a storage segment in this case especially includes the movement of its storage locations 12, wherein in this case a frame of the storage segment itself can also either be moved or not.

In order to change a sequence of the items of goods 4 of a stack among one another, but also to convey in its entirety a stack already built up into another storage location 12, the rotating storage device 10a includes two stack parking spaces 26a1, 26a2 disposed at two free points for use as intermediate storage devices. The stack parking spaces 26a1, 26a2 are disposed along the circumference of the at least one rotating storage device 10a, but could also be disposed at the position of a storage location 12, especially of the inner rotating storage device segment 24ai. For a storage device 5 not embodied as a rotating storage device 10, the one or more stack parking spaces 26 are disposed along the storage device 5 or in the storage device 2 itself. A configuration of a stack parking space in a storage location 12 is especially advantageous when it is not completely occupied and space is in short supply.

Each stack parking space 26a1, 26a2 is embodied for receiving and/or discharging one or more items of stacked goods 4, especially an entire stack. When two stacks in their entirety are transferred from two of the storage locations 12 into the stack parking spaces 26a1, 26a2, these two stacks can swap their position quite easily even with a completely filled rotating storage device 10a. In this way the sequence of the stacks in their storage locations 12 can be changed. This is suitable for speeding up the entire sorting process advantageously during inactive waiting times of the rotating storage device 10a. The changed sequence of the stacks can speed up the unloading.

When only one stack parking space 26a1 is provided instead of two stack parking spaces 26a1, 26a2, at least with a complete filling of all storage locations 12, only the sequence of individual items of goods 4 of a stack can be changed, however two stacks cannot be swapped in their entirety.

The consignment paths 8 leading to the sorting system 6 and the unloading area 18 can also be used for intermediate storage. The stack parking spaces 26a1, 26a2 are assigned yet another, optionally likewise fixed-location, stacking device 14a3, so that there can be automated stacking and/or unstacking into the stack parking spaces or out of one of the stack parking spaces 26a1, 26a2.

The stacking and/or unstacking of one or more items of goods 4 into one of or from one of the storage locations 12 from below requires that, for stacking of individual items of goods 4 one after the other, the item of goods 4 stacked first of all always remains the uppermost item of items of goods 4 of the stack. Advantageously therefore the items of goods 4, which are assigned to a common goods group of the sorting process, are allocated to a common storage location 12. A separation can take place again during unstacking. Without taking into account the stack parking space 26a it is correct to say that the number of orientations 11 of the consignment path 8, in which the goods 4 can in principle be conveyed after unstacking while maintaining the sorting result, at least corresponds to the number of goods groups that are stored in a stack. This has already been discussed in the description of FIG. 1. Even with a storage device 5, which is not embodied as a rotating storage device 10, the storage facility 2 can include one or more stack parking spaces 26, which are disposed along the at least one storage device. In this case too stack parking spaces 26 are embodied for receiving and/or discharging one or more items of stacked goods 4.

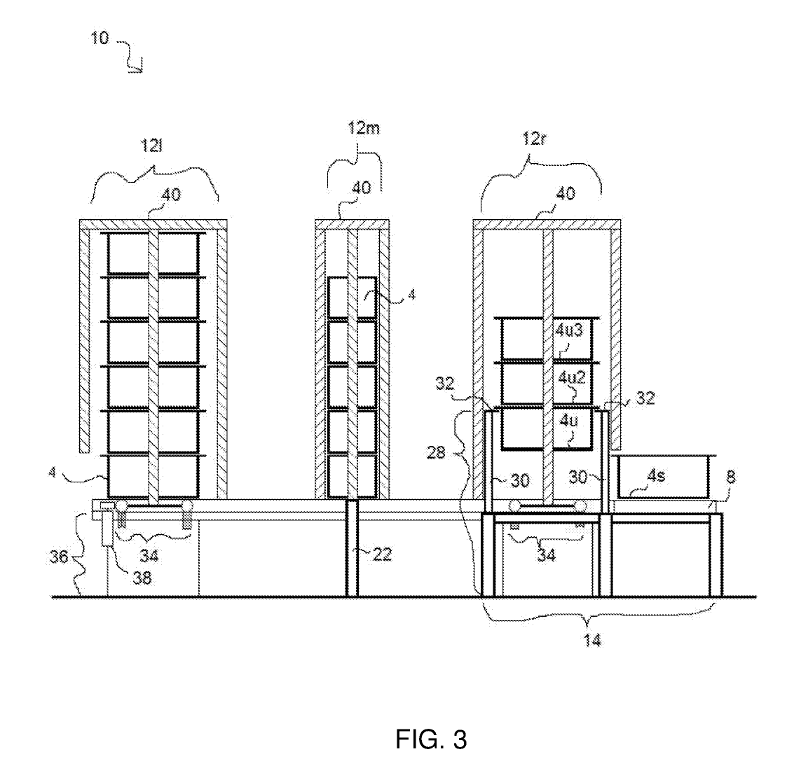

FIG. 3 shows a cross-section from the side of a rotating storage device 10 in accordance with a preferred embodiment of the invention. The cross-section includes the axis of rotation 22 of the rotating storage device 10 not embodied physically and it shows three storage locations 121, 12m, 12r. The left-hand storage location 121 in the diagrammatic representation is completely filled with six items of goods 4 forming a vertical stack. The central storage location 12m still offers space for one further item of goods 4 and the right-hand storage location 12r still offers space for three further items of goods 4.

An item of goods 4s is just being stacked into the right-hand storage location 12r. Since three items of goods 4u, 4u2, 4u3 are already present as a stack in the right-hand storage location 12r, this stack must first be raised slightly higher than the item of goods 4s to be inserted into the stack by a stack lifter 28 and held, in order to create space for the items of goods 4s to be stacked. In this way stacking from below is made possible. After the item of goods 4s has been introduced into the storage location 14r, the three items of goods 4u, 4u2, 4u3 are put back onto the newly stacked item of goods 4s, so that a new, expanded stack is formed. During unstacking too the stack is initially raised and held without the item of goods 4u to be unstacked, so that the item of goods 4u to be unstacked can subsequently be unstacked from the storage location 12r, without the weight of the remaining stack rendering the unstacking more difficult and/or a form lock preventing the unstacking. After the item of goods 4u has left the storage location 12r, the stack lifter 28 moves the remaining stack back downwards and puts it down.

The stack lifter 28 is thus embodied to lift and to hold one or more items of goods 4, especially the item or items of goods 4 that are already located in the storage location and also remain there, during the stacking and/or unstacking. The stack lifter 28 is formed of cross pieces 30 traveling above the stacks with outriggers 32, which come into contact below grip areas of the lowest item of goods 4u of the stack with just this lowest item of goods 4u and make a form-locking connection. The outriggers 32 must first be able to be manipulated for unstacking, since not the lowest item of goods 4u, but the second lowest item of goods 4u2 must be lifted up. Therefore, the outriggers 32 must preferably first pass the grip areas of the lowest item of goods 4u without making contact with them.

For stacking and/or unstacking, one or more items of goods 4 from below the storage location 12r and thus the rotating storage device 10 is rotated towards the stacking device 14. To this end the rotating storage device 10 is supported on support rollers 34 on a bearer frame 36. In this case a few or more of the outer support rollers are embodied as pulleys, in order to also guide the rotating storage device 10 at the side. A drive unit 38 effects a rotation of the rotating storage device 10, wherein the rotation of the rotating storage device 10 is automated with a control device. To this end the control device is adapted to explicitly rotate the rotating storage device 10. The rotating storage device 10 is not moved during stacking and unstacking itself.

In order to ensure that forces acting during the rotation do not cause any item of goods 4 to fall out of its storage location 12, each storage location 12 includes a support device 40 embodied to support stacked goods 4, which is positioned radially and axially. The support device 40 can be embodied to be open at the top or, as shown in FIG. 2, closed at the top, and makes high rotational accelerations possible. In order to ensure that the support device 40 does not hinder the stacking and unstacking, it has a cutout on the side of the stacking device 14 that is at least as wide and as high as an item of goods 4.

In accordance with a further preferred embodiment the storage facility 2 is embodied to carry out the stacking and/or unstacking from below in an automated manner. For this purpose the storage facility 2 includes a control device 7, which is adapted to activate the stacking device 14 so that an item of goods 4 and/or a plurality of items of goods 4 are stacked and/or unstacked from below, especially in a predetermined sequence. The drive unit 38 can also be activated with the control device 7. During stacking and/or unstacking from below with the stacking device 14, a stack can already be present in the storage location 12 or can remain in the storage location 12.

The control device 7 is also adapted to carry out the stacking and/or unstacking of the goods 4 in a predetermined sequence, wherein each item of goods 4 is allocated a storage location 12. The sequence is determined according to a sorting criterion for a sorting method, especially a multipass sorting method, in order to obtain a sorting result especially quickly. The storage facility 2 is thus embodied for sorting. This is able to be realized by the storage facility 2 being embodied for use within a sorting process, especially a sorting process with a sorting method. The control device 7 is adapted to determine the sequence of the stacking and/or unstacking for a sorting method.

The storage facility 2 can be operated in a fully automated or also only in a partly automated manner. The control device 7 is advantageously employed for this purpose.

1. A storage facility for the storage of stackable goods or stackable postal item containers, the storage facility comprising:
a) at least one storage device and at least one stacking device;
b) said at least one storage device including storage locations;
c) at least one of said storage locations being configured to receive at least two items of goods stacked on top of one another;
d) a mechanism being configured to move at least one of said at least one storage location or a further storage location within the storage facility; and
e) said at least one stacking device being configured to at least one of:
stack one or more of the items of goods into said at least one storage location from below, or
unstack one or more of the items of goods from said at least one storage location from below.

2. The storage facility according to claim 1, wherein said at least one stacking device is configured to at least one of stack the one or more items of goods into said at least one storage location or unstack the one or more items of goods from said at least one storage location to build up or taken down a stack from below, by at least one of inserting the one or more items of goods into said storage location or taking the one or more items of goods out of said storage location at least one of from a side or from below.

3. The storage facility according to claim 1, wherein said at least one storage device is a rotating storage device being rotatable about an axis of rotation with said mechanism, and said storage locations are disposed in at least one circumferential direction.

4. The storage facility according to claim 1, wherein said at least one stacking device is configured for at least one of:
automated stacking of at least one or a plurality of items of goods into said at least one storage location, or
automated unstacking of at least one or a plurality of items of goods from said at least one storage location.

5. The storage facility according to claim 1, which further comprises a control device being adapted to activate said at least one stacking device for at least one of:
stacking at least one or a plurality of items of goods from below into said at least one storage location, or
unstacking at least one or a plurality of items of goods from below from said at least one storage location.

6. The storage facility according to claim 5, wherein said control device is adapted to carry out at least one of a stacking or an unstacking of the items of goods in accordance with a predetermined sequence.

7. The storage facility according to claim 6, wherein said control device is adapted to determine the predetermined sequence of at least one of stacking or unstacking for a sorting method or a multipass sorting method.

8. The storage facility according to claim 1, wherein:
said at least one storage device includes a plurality of storage segments being at least one of movable jointly or movable independently of one another with said mechanism;
each of said storage segments includes one or more respective storage locations; and
said storage segments are disposed at least one of at an identical height or at a distance above one another.

9. The storage facility according to claim 1, wherein said at least one storage location includes a support device configured to support stacked items of goods.

10. The storage facility according to claim 1, wherein said at least one stacking device includes at least one of a loading or unloading device disposed in at least one of a loading or unloading area as well as an unloading device disposed in an unloading area.

11. The storage facility according to claim 1, wherein the storage facility is configured to be filled by a sorting system.

12. The storage facility according to claim 1, which further comprises at least one stack parking space configured for at least one of receiving or discharging at least one item of stacked goods.

13. The storage facility according to claim 1, wherein the storage facility is configured for sorting or for sorting with a sorting method.

14. The storage facility according to claim 1, wherein said at least one stacking device is configured to at least one of:
stack one or more items of goods from below into a stack already present in said at least one storage location, or
unstack one or more items of goods from below from a stack already present in said at least one storage location.

15. The storage facility according to claim 1, wherein:
at least one of said at least one storage location or said at least one stacking device includes a stack lifter; and
said stack lifter is configured to lift and hold one or more items of goods and to remain in place while one or more items of goods are being at least one of stacked or unstacked from below.

16. The storage facility according to claim 14, wherein:
at least one of said at least one storage location or said at least one stacking device includes a stack lifter; and
said stack lifter is configured to lift and hold one or more items of goods already located in said storage location and to remain in place while one or more items of goods are being at least one of stacked or unstacked from below.

17. A method for storing stackable goods or stackable postal item containers, the method comprising the following steps:
providing at least one storage device including storage locations; and
at least one of:
stacking one or more items of goods from below into at least one of the storage locations, or
unstacking one or more items of goods from below from at least one of the storage locations.

18. The method according to claim 17, wherein the at least one storage device is a rotating storage device.

19. The method according to claim 17, which further comprises:
using a mechanism to move the at least one storage device for moving the at least one storage location towards at least one of a stacking device or an operator; and
carrying out the step of at least one of:
stacking one or more items of goods from below into at least one of the storage locations, or
unstacking one or more items of goods from below from at least one of the storage locations.

20. The method according to claim 17, which further comprises allocating an item of goods to the at least one storage location for at least one of stacking or unstacking in a sorting method or a multipass sorting method.

21. The method according to claim 17, which further comprises at least one of carrying out the stacking starting from a sorting system or carrying out the unstacking towards a sorting system.

22. The method according to claim 17, which further comprises carrying out the step of at least one of stacking one or more items of goods from below into at least one of the storage locations or unstacking one or more items of goods from below from at least one of the storage locations, by lifting and holding a stack already present or remaining in the storage location or an item of goods already present or remaining in the storage location.

23. The method according to claim 17, which further comprises at least one of:
automating the entire method, or
automating at least one of stacking one or more items of goods from below into at least one of the storage locations or unstacking one or more items of goods from below from at least one of the storage locations, or
automating a movement of the at least one storage device with a mechanism to move the at least one storage location towards a stacking device or an operator, and at least one of stacking one or more items of goods from below into the at least one storage location or unstacking one or more items of goods from below from the at least one storage location, or
automating an allocation of an item of goods to the at least one storage location for at least one of stacking or unstacking in a sorting method or a multipass sorting method, or
automating at least one of stacking starting from a sorting system or unstacking towards a sorting system, or
automating at least one of stacking one or more items of goods from below into at least one of the storage locations or unstacking one or more items of goods from below from at least one of the storage locations, or
automating lifting and holding of a stack of goods already present or remaining in a storage location or an item of goods already present or remaining in the storage location.
